(19) United States
(12) Patent Application Publication
(10) Pub. No.: US 2009/0188695 A1
(43) Pub. Date: Jul. 30, 2009

(54) NANOSTRUCTURES AND METHOD FOR MAKING SUCH NANOSTRUCTURES

(75) Inventors: Peter Klaus Bachmann, Wuerselen (DE); Zexiang Chen, Aachen (DE); Jacqueline Merikhi, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V., Eindhoven (NL)

(21) Appl. No.: 10/599,999

(22) PCT Filed: Apr. 15, 2005
(86) PCT No.: PCT/IB2005/051242

§ 371 Date: Oct. 17, 2006

(30) Foreign Application Priority Data
Apr. 20, 2004 (EP) 04101616.3

(51) Int. Cl. H01B 5/00; B05D 5/12

(52) U.S. Cl. 174/126.1; 427/58

(57) ABSTRACT

The invention provides nanostructures, being arrays of nanosized filamentary material such as carbon nanotubes (CNTs) and other nanomaterials and especially to such materials connected to a substrate such as at least one top electrode and one bottom electrode, and to a method for manufacturing such nanostructures. A device according to the present invention comprises a first and a second layer (11, 13) separated from each other; and nanosized filamentary material (10) grown between said first and said second layer (11, 13). The shape and size of the nanosized filamentary material is determined by the shape and size of the second layer. A corresponding method for growing the nanosized filamentary material is also provided.

The present invention relates to nanostructures, being arrays of nanosized filamentary material such as carbon nanotubes (CNTS) and other nanomaterials and especially to such materials connected to a substrate such as at least one top electrode and one bottom electrode, and to a method for manufacturing such nanostructures. Furthermore, the invention relate to devices that are based on such nanostructures and to a method of manufacturing such devices.

Nanomaterials or nanosized filamentary materials such as nanowires and nanotubes have attracted much interest as potential building blocks for nanotechnology. This interest can be traced to the novel structural and electronic properties of these nanomaterials. However, the study of 1-dimensional (1-D) structures has been largely restricted due the difficulties encountered in their synthesis.

Nanowires and nanotubes efficiently carry charge and excitons, and are therefore potentially ideal building blocks for e.g. nanoscale electronics and opto-electronics. Carbon nanotubes (CNTs), for example, have already been exploited in devices such as field-effect and single-electron transistors, but the practical utility of nanotube components for building electronic circuits is limited. Over the past decade, the synthesis of various nanomaterials has attracted attention due to their potential to serve as building blocks for emerging nanoscale devices. Among them, the electronic and sensing properties of nanowires and nanotubes have been widely studied because of their nanoscale dimensions and high surface-to-volume ratios.

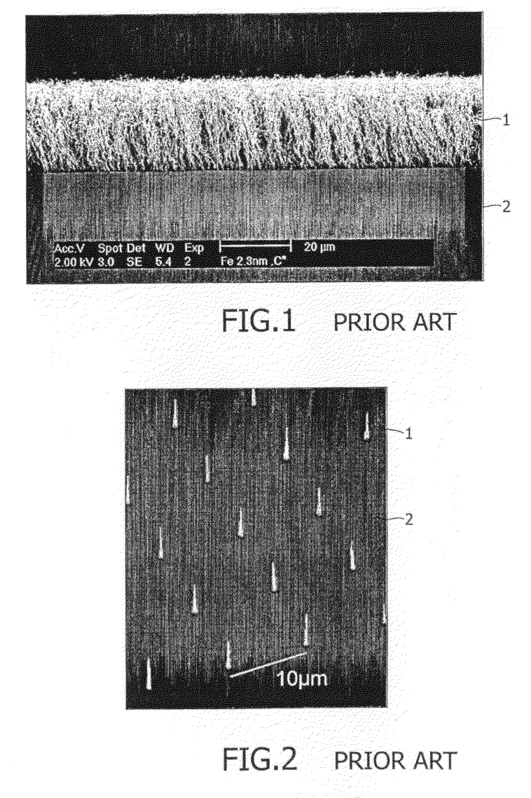

Growth of CNTs and other nanomaterials by catalyst-supported chemical vapor deposition processes, e.g. thermal CVD or plasma CVD processes is in general known. It is furthermore known, that structuring of a catalyst layer of a generic stack of substrate/buffer layer/catalyst layer leads to structured growth of CNTs and other nanomaterials. It is also known that plasma-grown CNTs can be grown vertically aligned from gas mixtures that contain a carbon carrier (methane, acetylene or other), hydrogen, and other gases (ammonia, nitrogen) (see FIG. 1 and FIG. 2). The SEM-picture of FIG. 1 illustrates plasma-CVD grown vertically aligned CNTs 1 onto a substrate 2. FIG. 2 shows a SEM picture of plasma-CVD grown vertically aligned carbon nanostructures 1 onto a substrate 2.

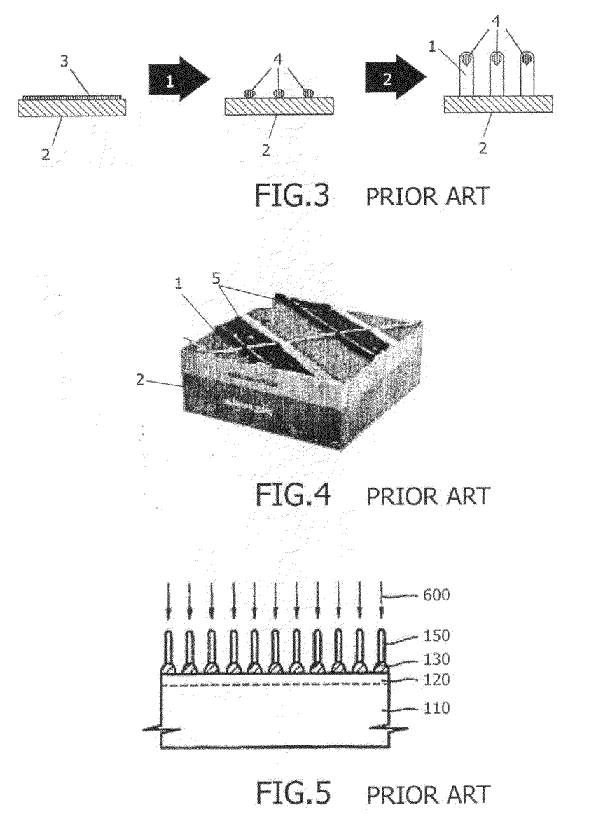

FIG. 3 illustrates a catalyst-assisted CVD growth of CNTs 1. It is common to provide the catalyst 3 as a sputtered or evaporated continuous metal layer (e.g. Fe, Co, Ni or other suitable metals) on a substrate 2 or parts of a substrate 2, e.g. by using masks. In the course of growth, these catalyst layers 3 are heated (step 1) and break up into catalyst nanoparticles 4 that will define the CNT characteristics such as e.g. diameter, number of walls, etc. Deposition of individual nanoparticles 4 or structuring of a catalyst layer 3 into nanoparticles 4 leads to growth of individual CNTs 1 at well-defined, pre-determined sites, via CVD (step 2). The nanotube diameters thus obtained range in the order of 40-70 nm.

Moreover, it is known, that CNTs may be used as relevant components in transistors or sensors. In FIG. 4, a CNT based transistor, comprising a substrate 2 with a single horizontal CNT 1 connecting two metal electrodes 5, is illustrated. Sensor elements that use changes of the CNT properties upon gas adsorption or other surface modifications are also known. In such devices and sensors, the CNTs are contacted by positioning them horizontally across electrode stripes. Electron transport phenomena or conductivity changes upon surface modifications are measured this way. Indirect measurements by capacitance changes are used as possible, rather difficult to measure alternative with limited practical relevance.

In EP-1 061 043 a method for the synthesis of CNTs 150 using a metal catalyst layer is described (see FIG. 5). The CNTs 150 may be applied in field emission devices (FEDs) or white light sources. It is preferable to form a metal layer (not shown) over an insulating layer 120 on top of a first substrate 110 before the formation of a metal catalyst layer. The metal layer may then be used as electrode for the required devices. A second substrate (not shown in the figure) is prepared by providing a metal catalyst layer on it for decomposing carbon source gas.

The metal catalyst layer on the first substrate 110 is then etched to form independently isolated nanosized catalytic metal particles 130 by means of a plasma etching or wet etching technique. Then, CNTs 150 are grown from the catalytic metal particles 130 by thermal CVD using the metal catalyst layer of the second substrate for decomposing carbon source gas 600, used for the growth of the CNTs 150. Both the first and second substrate are arranged such that the surface of the catalytic metal particles 130 faces the opposite direction of the flow of carbon source gas 600 because a uniform reaction over the first substrate 110 coated by the catalytic metal particles 130 may be achieved. According to the method of EP-1 061 043, CNTs may be produced having a diameter of a few nanometer to a few hundred nanometer, for example, 1 to 400 nm, and a length of a few tenth of a micrometer to a few hundred micrometer, for example 0.5 to 300 μm Furthermore, high purity uniform CNTs may be uniformly and vertically aligned over the substrate.

A drawback, however, of this method is that, when contact terminals have to be provided to the device, a conductive layer still has to be deposited onto the grown CNTs, so as to be able to contact the device. This is difficult to perform due to the minute sizes of the devices and requires an additional step.

It is an object of the present invention to provide improved nanostructures and nanostructured devices, comprising nanosized filamentary material, as well as methods of making and using such structures.

The above objective is accomplished by a method and device according to the present invention.

In one aspect of the present invention, a device is provided comprising a first and a second layer separated from each other and nanosized filamentary material grown between the first and the second layer. By integrally growing the nanosized filamentary material between the first and the second layer, i.e. the first and second layers and the nanosized material in between form one integral structure, problems with having to apply a further layer on top of the nanosized filamentary material, such as for example, but not limited thereto, a contact layer, are avoided.

The shape and the size of the nanosized filamentary material may be determined by the size and the shape of the second layer. The second layer is typically more easy to pattern than the structure of layer formed of grown nanosized filamentary material, therefor the present invention is advantageous as nanosized filamentary material is only grown to a useful extent there where the second layer is present on top of a catalyst layer.

The first and second layer may be conductive, semiconductive and even insulating, depending on the required application. In case the first and second layers are conductive, the step of growing the nanosized filamentary material makes an electrically conductive connection to the second layer. Where the first and second layers are conductive, the device may further comprise at least a bottom contact and a top contact, the bottom contact being connected to the first layer and the top contact being connected to the second layer. Hence the device according to the present invention is an easy to contact, e.g. two-terminal device. In one embodiment, the first and/or second layer may consist of a flexible material.

A device according to the present invention may comprise free-standing nanosized filamentary material. The filamentary material may comprise carbon nanotubes or nanowires. The nanowires may be formed out of one of Si, GaAs, Si₃N₄, Ge, GaN, GaP, InP, AlN,_BN_or SiC.

In one embodiment of the invention, the device may be an electronic device, such as for example a sensor.

The invention furthermore discloses an array comprising a plurality of devices according to the invention.

In a second aspect of the invention, a method for the manufacturing of nanosized filamentary material is provided. The method comprises:
providing a stack comprising at least a first catalyst layer which is catalytically active with respect to the growth of nanosized filamentary material and which is provided in between at least a first layer and a second layer, the first and second layer being inert with respect to the growth of nanosized filamentary material, and
growing nanosized filamentary material in between said first and second layer, whereby the first catalyst layer is converted into a layer comprising the nanosized filamentary material.

By applying the method as described above, the grown nanosized filamentary material, CNTs for example, are connected to two solid surfaces, i.e. the first layer or substrate on the one hand and the second layer or cover on the other hand. These solid surfaces may be made out of conductive, semiconductive or insulating material. In case the substrate and cover are made out of conductive material, they can be used as contact terminals. Hence, the method of the present embodiment of the invention provides an easy way to create contactable, e.g. 2-terminal, nanostructures with nanosized filamentary material, e.g. CNTs, connecting massive, easy to contact (e.g. by wire bonding) bottom and top terminals.

Providing a stack may comprise providing the first layer, providing the first catalyst layer onto at least part of the first layer and providing the second layer on top of at least part of the first catalyst layer. Providing the first catalyst layer on top of at least part of the first layer may be performed by depositing a metal layer on at least part of the first layer. This may be performed by any suitable deposition technique such as for example chemical vapor deposition (CVD). Providing the second layer on top of at least part of said first catalyst layer may comprise depositing a conductive layer.

In an embodiment, the first layer may lie in a first plane, the catalyst layer may lie in a second plane and the second layer may lie in a third plane. The first, second and third planes preferably being substantially parallel with each other. However, in another embodiment of the invention, the first layer may lie in a first plane, the second layer may lie in a second plane, the first and the second plane including a first angle between them, and the catalyst layer may have a wedge shaped form, the wedge including a top angle, the top angle of the wedge being substantially equal to the first angle.

Growing nanosized filamentary material in between the first and second layer may preferably be performed by a chemical vapor deposition (CVD) technique. In a preferred embodiment, growing the nanosized filamentary material may be performed by microwave plasma CVD. However, in other embodiments, also radio frequency (RF) CVD, plasma enhanced (PE) CVD or any other suitable CVD technique may be used.

The nanosized filamentary material may comprise carbon nanotubes or may comprise nanowires. The nanosized filamentary material may comprise one of Si, GaAs, Si₃N₄, Ge, GaN, GaP, InP, Al_BN_or SiC.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference numbers quoted below refer to the attached drawings.

FIG. 1 is a SEM picture of plasma-CVD grown vertically aligned CNTs according to the state of the art.

FIG. 2 is a SEM picture of patterned plasma-CVD grown vertically aligned carbon nanostructures according to the state of the art.

FIG. 3 illustrates a conventional catalyst-assisted CVD growth of CNTs.

FIG. 4 is a state of the art CNT-based transistor prototype device with a single horizontal CNT connecting two metal electrodes.

FIG. 5 illustrates a CNT-based device according to the state of the art.

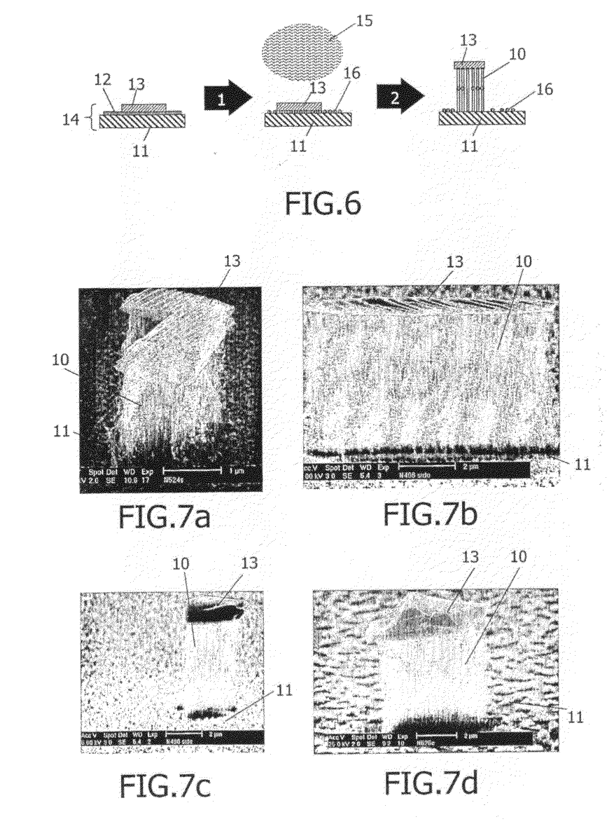

FIG. 6 schematically illustrates the growth of nanosized filamentary material from sandwiched substrate/catalyst-structures according to an embodiment of the invention.

FIGS. 7a-7d show some examples of experimental CNT structures fabricated according to a method according to the present invention.

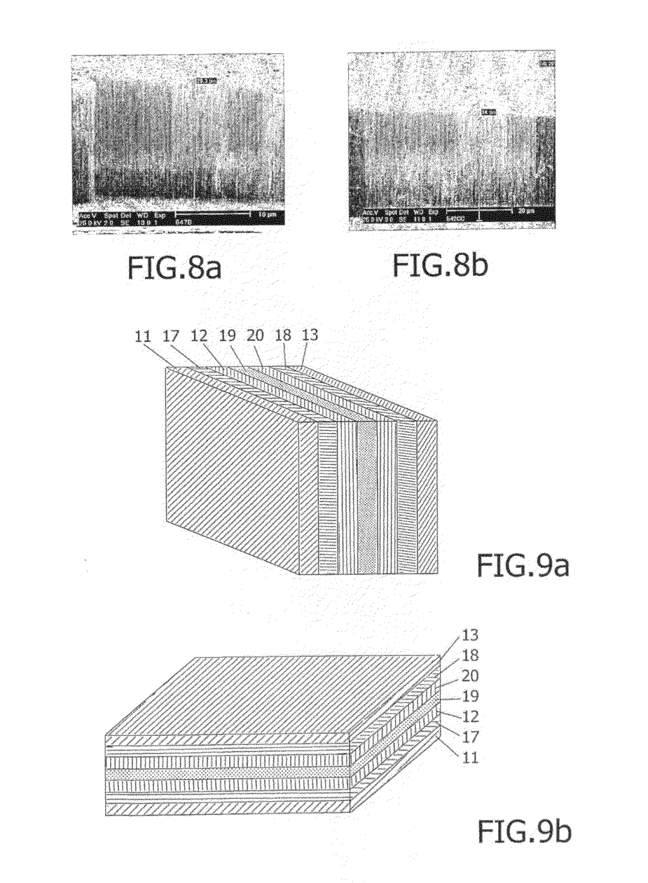

FIGS. 8a and 8b show SEM pictures of CNTs grown according to an embodiment of the invention after removal of the cover.

FIGS. 9a and 9b illustrate possible arrangements for a material stack according to embodiments of the invention.

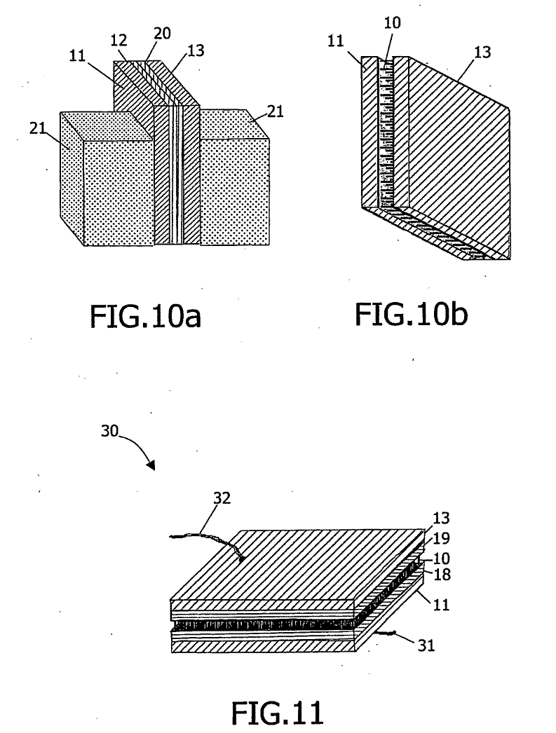

FIGS. 10a and 10b illustrate CNT growth starting from a vertically aligned material stack.

FIG. 11 illustrates a gas sensing device according to an aspect of the present invention.

In the different figures, the same reference numbers refer to the same or analogous elements.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

The present invention provides a method for manufacturing catalytically grown nanomaterials or nanosized filamentary materials, such as e.g. nanotubes, in particular carbon nanotubes (CNTs), or nanowires, connected to a substrate. The substrate may be at least one contact terminal, preferably at least two contact terminals, for example, at least one top contact terminal and a least one bottom contact terminal. The present invention furthermore provides multi-terminal electronic devices and sensors comprising such nanosized filamentary material as well as a method for manufacturing such devices. In addition, the invention provides array structures of the above-mentioned devices.

In the following description, the invention will be explained with respect to CNTs as nanomaterials. However, the invention is not limited to growth and use of CNTs, but to different kinds of nanomaterials, in particular nanosized filamentary materials, such as nanowires or nanotubes comprising e.g. Si, GaAs, Si₃N₄, Ge, GaN, GaP, InP, AlN, BN and/or SiC. Nanotubes are a sub-group of nanowires. If, in case of e.g. carbon, growth conditions (concentration, temperature, pressure, . . . ) are properly selected then nanotubes are formed. If, for example, temperature is too low, then defects are created and wire-like, filamentary structures are obtained. These wires are filled, rather than hollow and are less ordered structures. The materials the nanowires and nanotubes are made of course, depend on the starting materials. Their respective structure (wire vs. tube vs. amorphous mass) depends on the size and kind of catalysts used and the deposition conditions applied. In the following description, when terms like nanomaterials, nanowires, nanotubes are used, structures are meant with at least one dimension with is less than 150 nm, i.e. between 1 and 150 nm.

Nanotubes are hollow, tubular and caged molecules and may be conductive, e.g. metallic, semiconductive or even insulating. Carbon nanotubes (CNTs) are conductive or semi-conductive and hence, offer possibilities to create electronic device structures, e.g. semiconductor-semiconductor and semiconductor-metal junctions. Furthermore, CNTs are high aspect-ratio structures with good electrical and mechanical properties. Properties and structure of CNTs may be found in ‘Handbook of Nanoscience, Engineering and Technology’, Edited by W. A. Goddard, m; D. W. Brenner, S. E. Lyshevski and G. J. Lafrate, CRC Press, 2003.

In a first aspect of the present invention, a method for manufacturing an array of free-standing CNTs 10 is described. FIG. 6 schematically illustrates the growth process of CNTs 10 according to an embodiment of the present invention. First, a substrate 11, onto which the CNTs 10 will be grown, is provided. The substrate 11 may for example be a semiconductor layer such as e.g. silicon or any other suitable semiconductor material, a metal layer such as e.g. copper or gold or a conductive polymer layer. In one embodiment of the invention, the substrate 11 may be an insulator. In another embodiment of the invention, the substrate 11 may be flexible and may for example be a thin metal film or a polymer. It is to be noted that the substrate 11 material should be non-catalytic with respect to CNT growth.

On the substrate 11a first catalyst layer 12 is provided. The first catalyst layer 12 may be a continuous layer, for example a metal layer comprising e.g. Ni, Fe, Co, or a layer comprising any other suitable material with appropriate catalytic properties such as e.g. PdSe, FeZrN, metal alloys (e.g. Co—/Mo) or Co-, Ni-, Fe-salts that are dissolved, spun on, dried and converted during processing into a catalyst. Alternatively, the first catalyst layer 12 may comprise nanoparticles such as e.g. ex-situ formed spray-on nanoparticles.

In case the first catalyst layer 12 is a continuous layer, as in the embodiment of the invention presently being described, it may be deposited onto the substrate 11 by any conventional deposition technique, such as e.g. evaporation, sputtering, CVD, wet chemical methods, etc. The thickness of the first catalyst layer 12 will later determine the size of the formed CNTs 10. The layer will, later on, break into particles 16 (see further) and the size of these particles 16 will determine the size of the CNTs.

Next, a layer of a cover material, which again is non-catalytic with respect to the CNT growth and which in the further description will be referred to as cover 13, is provided, e.g. deposited, on top of at least part of the first catalyst layer 12. The layer of cover material may for example comprise a semiconductor layer, such as e.g. silicon or any other suitable semiconductor material, may comprise a metal layer such as e.g. copper or gold or may comprise a conductive polymer layer. Insulators, however, may also be used. The cover 13 may be provided e.g. by means of any suitable deposition technique such as e.g. evaporation, sputtering, CVD, wet chemical methods, etc. The cover 13 may preferably lie in a plane substantially parallel to the plane of the substrate 11 and to the plane of the catalyst layer 12. However, the catalyst layer 12 may be a wedge shaped layer, such that the cover layer includes an angle with the plane of the substrate 11, but lies in a plane substantially parallel to the plane of the catalyst layer 12.

The size and form of the cover 13 will later determine the size and form of the CNT nanostructure that will be formed (see further). The thickness of the cover 13 may for example be between 2 nm and 2 mm, e.g. 0.5 mm. The cover 13 may be as thin as possible to still achieve a continuous layer. If the layer gets too thin, it may possibly comprise holes and may thus not form a continuous layer.

Thus, as can be seen from FIG. 6, the first catalyst layer 12 is, for a well defined region on the substrate 11, covered with the cover 13 comprising cover material.

The above-mentioned layers form a substrate/catalyst/cover stack 14 as can be seen from FIG. 6. According to the present invention, substrate 11 and cover 13 may be formed out of the same material, but this is not necessary.

A method according to the present invention then comprises two steps: a catalyst nanoparticle forming step, and a nanomaterial growing step.

During the catalyst nanoparticle forming step, the entire stack is heated. This heating may be performed e.g. by a plasma 15, e.g. a nanotube-material comprising plasma, which will then also be used for the nanotube growth. Alternatively, heating may also be performed by any other suitable heat source, such as for example a resistance heater provided underneath the substrate 11, at the side opposed to the side onto which the first catalyst layer is applied. Temperatures may be elevated to higher than 100° C., preferably higher than 300° C. (step 1 in FIG. 6). During this step, the catalyst layer 12 is deformed into catalyst nanoparticles 16.

In a further step (step 2 in FIG. 6), the nanomaterial growing step, CNTs 10 are grown (in the example given) by means of e.g. plasma CVD, using nanotube-comprising-plasma. For the present invention, microwave plasma enhanced chemical vapor deposition (MPECVD) is preferred for CNT growth, as it is known that using this growth method leads to a better alignment of the growing nanotubes 10 and to the ability to use lower deposition temperatures with respect to other CVD methods. However, other CNT growth methods may also be used, such as e.g. thermal chemical vapor deposition (TCVD) or plasma enhanced chemical vapor deposition (PECVD) or any other suitable CVD technique.

It is observed that the CNTs 10 grow at a much higher speed and with a much smaller diameter at those places of the substrate 11 covered by cover 13 than elsewhere, where the substrate 11 is not covered by cover 13, even if the entire substrate 11 is coated with catalyst material 12. The diameter of the CNTs 10 grown under the cover 13 is between 20 and 50% of that of the CNTs 10 elsewhere. The growth rate under the cover 13 is experimentally found to be 5 to 15 times higher than at positions where the substrate 11 is not covered with the cover 13. This leads to structures where the cover 13 is lifted by the growing CNTs 10 and remains on top of the grown CNT tips. The CNTs 10, grown according to the method of this embodiment, grow in a direction substantially perpendicular to the plane of the substrate 11. By applying the method as described above, the CNTs 10 are connected to two solid surfaces, i.e. the substrate 11 on the one hand and the cover 13 on the other hand. These solid surfaces may be made out of conductive, semiconductive or insulating material. In case the substrate 11 and cover 13 are made out of conductive or semiconductive material, they can be used as contact terminals. Hence, the method of the first embodiment of the invention provides an easy way to create 2-terminal nanostructures with free-standing CNTs 10 connecting massive, easy to contact (e.g. by wire bonding) bottom and top terminals, respectively the substrate 11 and cover 13.

FIGS. 7a-7d illustrates some experimental structures manufactured using the method according to the first embodiment of this invention, comprising a substrate 11 which may form a bottom contact terminal, CNTs 10 aligned in a direction substantially perpendicular to the plane of the substrate 11 or thus of the bottom contact terminal, and a cover 13, which may form the top contact terminal.

The present invention provides ways to structure CNT growth by lithographical etching techniques in order to build complex device structures. Although the entire surfaces of the substrates 11, visible in FIGS. 7a-7d, are covered with a catalytic material 12, fast CNT growth is only seen in the “sandwich” region, i.e. in areas where the catalyst layer 12 was positioned or sandwiched in between two catalytically inactive parts, i.e. in between the substrate 11 and the cover 13.

Furthermore, FIGS. 7a-7d also illustrate that the CNTs 10 are aligned in a direction substantially perpendicular to the plane of the substrate 11, i.e. vertically aligned in case of the examples given, and are capable to lift and suspend the cover 13. Moreover, FIG. 7 illustrates that the shape of the cover 13 determines the shape of the CNT growth region and that the CNTs 10, grown between the substrate 11 and the cover 13 using the method according to the present invention, are of uniform length. FIG. 8 shows SEM pictures of CNTs 10 after removal of the cover 13 after the growth process. The CNTs 10 grown underneath the cover 13 are extremely well aligned and are of uniform length, thus illustrating one advantage of the method according to the invention.

In the first embodiment of the method, the material stack 14 comprises a substrate 11, a catalyst layer 12 and a cover 13. However, in other embodiments of the present invention, the stack 14 may be more sophisticated in order to improve its performance. The stack 14 may, besides a substrate 11, a first catalyst layer 12 and a cover 13, in one embodiment, furthermore comprise a first diffusion barrier layer 17 in between the substrate 11 and the first catalyst layer 12 and/or a second diffusion barrier layer 18 in between the first catalyst layer 12 and the cover 13 in order to prevent chemical reactions between the first catalyst layer 12 and the substrate 11 on the one hand and in between the first catalyst layer 12 and the cover 13 on the other hand. The first and second diffusion layers 17, 18 may for example comprise nitrides, e.g. TiN, oxides, carbide or mixtures thereof and may have a thickness of between e.g. 0.1 and 100 nm. Also different types of amorphous carbon layers and CVD diamond layers may act as diffusion barriers. Optionally, the stack 14 may furthermore comprise a sacrificial layer 19 on top of the first catalyst layer 12, in between the first catalyst layer 12 and the cover 13, and a second catalyst layer 20 between the sacrificial layer 19 and the cover 13. The sacrificial layer 19 may be any suitable material than can be selectively removed without affecting the catalytic action of the catalyst layer(s) 12, 20 such as e.g. an organic layer that is dissolved after patterning or that evaporates at elevated temperatures (e.g. poly-vinyl-acetate (PVA), acrylate layers). The sacrificial layer 19 may have a thickness of between 1 and 100 nm.

The second catalyst layer 20 may be a continuous layer, for example a metal layer comprising e.g. Ni, Fe, Co or a layer comprising any other suitable material with appropriate catalytic properties such as e.g. PdSe, FeZrN, metal alloys (e.g. Co—/Mo) or Co-, Ni-, Fe-salts that are dissolved, spun on, dried and converted during processing into a catalyst, or the first catalyst layer 12 may comprise nanoparticles such as e.g. ex-situ formed spray-on nanoparticles. The second catalyst layer 20 may be of the same material as the first catalyst layer 12, or they may be of different materials.

All layers of stack 14, both of the most simple stack or the more sophisticated stack, may be deposited by means of any suitable deposition method such as e.g. evaporation, sputtering, CVD or wet chemical methods. The layers may be structured according to the device that is required by means of for example lithography or any other suitable technique.

FIGS. 9a and 9b illustrate a stack 14 comprising a substrate 11, a first and a second catalyst layer 12, 20, a sacrificial layer 19 in between the first and second catalyst layer 12, 20 and a first and second diffusion barrier layer 17, 18. This material stack 14 may be arranged vertically (FIG. 9a) or horizontally (FIG. 9b). The example of sequence of layers illustrated in this figure, however, is not limiting to the invention. It is an example only, and several different combinations of the described and suitable other layers are possible and may be used with embodiments of the present invention.

FIGS. 10a and 10b illustrate CNT growth which has started form a vertically aligned stack 14 comprising a substrate 11, a first and a second catalyst layer 12, 20 and a cover 13, supported by holders 21. The stack 14 in this example is formed by applying on top of each other two solid surfaces, respectively substrate 11 and cover 13, coated with a first respectively second catalyst layer 12, 20, with the catalyst layers 12, 20 facing each other.

In this example, the cover 13 may comprise the same material as the substrate 11 and may for example be a semiconductor (e.g. silicon), a metal (e.g. copper), a conductive polymer or even an insulator. The vertically aligned stack orientation, shown in this figure, leads to the horizontally aligned CNT-structure as depicted in FIG. 10b.

Hereinafter, some specific examples with regard to the method of the present invention will be described.

In a first example, CNT growth is performed starting from a stack 14 comprising a silicon layer as a substrate 11, an iron layer with a thickness of 2 nm as a catalyst layer 12 and a silicon layer as a cover 13. The stack 14 is mounted horizontally (as in FIG. 9b) on a substrate heating stage inside a microwave cavity of a reactor. Hydrogen is then introduced into the reactor at a rate of 200 sccm. The pressure of the reactor is kept at 28 mbar. The silicon substrate 11 is heated to 600° C. and a 1 kW 2.45 GHz microwave plasma 15 is ignited. Methane is then added to the gas phase inside the reactor at a rate of 10 sccm while the pressure is kept constant. After 1 min. of growth time 5 μm long CNTs 10 are grown underneath the covered area, thus electrically connecting horizontal bottom and top of the device structure by a multitude of vertically aligned CNTs 10.

In a second example, the same stack 14 as in the first example is now vertically mounted on a substrate heating stage inside the microwave cavity of a reactor (as in FIG. 9a and in FIG. 10a). The same process flow as in the first example is performed, except for the growth time. Now, CNTs 10 are grown for 3 minutes. This results in 20 μm long CNTs 10 horizontally aligned between the substrate 11 and the cover 13, thus electrically connecting two solid vertical terminals of the device structure by a multitude of horizontally aligned CNTs 10.

In a further aspect of the invention, devices comprising CNT structures as set out above, are provided. Any device, such as e.g sensors or electronic devices such as e.g. transistors, comprising nanosized filamentary materials formed by the method according to this invention and thus comprising at least two contact terminals directly attached to and thus contacting one or more free-standing CNTs 10 are included within the scope of the present invention.

As an example, but not limiting the invention, a two-terminal device 30, e.g. a sensor based on resistance changes induced by adsorption of gas molecules, will be described hereinafter and illustrated in FIG. 11. The CNTs 10 in the device 30 of FIG. 11 are grown according to the method as set above, starting from a stack 14 comprising a substrate 11 and a cover 13, possibly of the same material, with a first catalyst layer 12 in between which is converted into CNTs 10 by means of plasma CVD. The stack 14 may furthermore comprise a first and second diffusion barrier layer 17, 18. The substrate 11 and cover 13 may be contacted by a bottom contact 31 and a top contact 32 connected to the solid material of the substrate 11 and to the material of the cover 13, respectively. A multitude of vertically aligned CNTs 10 electrically connect the substrate 11 and the cover 13, and thus the bottom contact and the top contact.

It is known from the prior art that the resistance of CNTs 10 changes when gases such as e.g. ammonia, NO₂, . . . , are absorbed on their surface. A multitude of freestanding CNTs 10 in this device 30 can interact with a gas flowing in between them, through which their conductivity changes. This conductivity change may easily be measured between the top and bottom contacts 31, 32. Such devices 30 may, e.g. used in the medical field as a biosensor e.g. in breath analysis to detect CO₂, NH₃, NO₂, NO and other exhaled breath components. Accordingly, the present invention includes a CNT device as made in accordance with any embodiment of the present invention coupled to electronic sensing circuitry, e.g. electronic sensing circuitry for measuring an electrical property of the CNTs, such as detecting changes in conductivity, impedance, frequency response, etc. Another application area is e.g. sensitive measurement of environmental pollutants.

In yet another aspect of the invention, arrays comprising a plurality of nanostructured two-terminal devices 30 as described above, are provided. The devices 30 may be fabricated onto the same substrate 11 by using e.g. lithography.

The use of the ‘sandwiched’ substrate-catalyst-cover stack 14, according to the present invention, leads to entirely different structures and properties than the conventional technical approach without such ‘sandwich’ structures.

Another advantage of the invention is that by the right choice of the cover 13, arrays of CNTs, or in general, arrays of nanosized filamentary material, with all sorts of sizes and forms may easily be achieved. Moreover, CNTs 10 or any other nanosized filamentary material grown by the method of the present invention, show uniform heights. Furthermore, the approach of the present invention opens new ways to structure CNT growth by lithographical etching techniques in order to build complex device structures.

It is to be understood that although preferred embodiments, specific constructions and configurations, as well as materials, have been discussed herein for devices according to the present invention, various changes or modifications in form and detail may be made without departing from the scope and spirit of this invention. For example, instead of CNTs 10, also other nanomaterials may be grown according to the method of this invention, such as nanowires. Furthermore, the nanosized filamentary materials may comprise e.g. Si, GaAs, Si₃N₄, Ge, GaN, GaP, InP, AlN, BN and/or SiC.

1. A device comprising:
a first and a second layer (11, 13) separated from each other; and
nanosized filamentary material (10) grown between said first and said second layer (11, 13).

2. A device according to claim 1, wherein the size and shape of the nanosized filamentary material (10) is determined by the size and shape of the second layer (13).

3. A device according to claim 1, wherein the first and second layers (11, 13) are conductive.

4. A device according to claim 3, further comprising:
at least a bottom and a top contact (31, 32), said bottom contact (31) being connected to the first conductive layer (11) and said top contact (32) being connected to the second conductive layer (13).

5. A device according to claim 1, wherein the device is an electronic device.

6. A device according to claim 5, wherein the device is a sensor.

7. An array comprising a plurality of devices according to claim 1.

8. A method for manufacturing nanosized filamentary material (10), the method comprising:
providing a stack (14) comprising at least a first catalyst layer (12) which is catalytically active with respect to the growth of nanosized filamentary material (10) and which is provided in between at least a first layer (11) and second layer (13), said first and second layer (11, 13) being inert with respect to the growth of nanosized filamentary material (10);
growing nanosized filamentary material (10) in between said first and second layer (11, 13) whereby said first catalyst layer (12) is converted into a layer comprising the nanosized filamentary material (10).

9. A method according to claim 8, wherein growing nanosized filamentary material (10) in between said first and second layer (11, 13) is performed by a chemical vapor deposition (CVD) technique.

10. A method according to claim 8, wherein providing a stack (14) comprises:
providing said first layer (11),
providing said first catalyst layer (12) onto at least part of said first layer (11), and
providing said second layer (13) on top of at least part of said first catalyst layer (12).

11. A method according to claim 10, wherein providing said first catalyst layer (12) onto at least part of said first layer (11) is performed by depositing a metal layer on at least part of said first layer (11).

12. A method according to claim 10, wherein providing said second layer (13) on top of at least part of said first catalyst layer (12) is performed by depositing a conductive layer.
